(19) United States
(12) Patent Application Publication
(10) Pub. No.: US 2007/0189945 A1
(43) Pub. Date: Aug. 16, 2007

(54) Method for the treatment of salt brine

(76) Inventors: Thorsten Kopp, Hannover (DE); Heinz-Jurgen Barge, La Leeuwarden (NL)

Correspondence Address: WILLIAM COLLARD;COLLARD & ROE, P.C., 1077 NORTHERN BOULEVARD, ROSLYN, NY, 11576, US

(21) Appl. No.: 11/652,406

(22) Filed: Jan. 11, 2007

(30) Foreign Application Priority Data
Jan. 12, 2006 (EP) 06000551.9-2111

(51) Int. Cl. C01F 5/00; C01D 3/00

(52) U.S. Cl. 423/158; 23/303

(57) ABSTRACT

A method for purifying salt brine to obtain a highly pure sodium chloride from the purified brine by means of crystallization. Nanofiltration directly follows a two-stage brine purification according to the Schweizerhalle method, as a third purification stage, and the permeate of the nanofiltration is a highly pure brine. The concentrate from this step is recirculated into the first stage of the brine purification.

### BACKGROUND OF THE INVENTION

1. Field of the Invention

The present invention relates to a method for purifying salt brine. Highly pure sodium chloride, concerning the contaminants bromide, sulfate, microparticles, germs, endotoxins, and bivalent cations, can be obtained from this treated salt brine, by means of crystallization. This sodium chloride (evaporated salt) is particularly suitable for use in electrolysis or as a pharmaceutical salt.

2. The Prior Art

Evaporated salt low in bromine is increasingly in demand from customers of chlor-alkali electrolysis, because the bromide that is otherwise crystallized into sodium chloride enters the chlorine stream during electrolysis of the salt. A chlorine gas product that contains bromine causes quality problems.

In pharmaceutical applications, there are state-specific legal limits, particularly for sulfate, bromide, and pyrogens in sodium chloride. Evaporated salt produced in a conventional manner frequently does not meet all of the requirements. In order to adhere to the sulfate content, significant washing water amounts in pure water quality are sometimes required. Bromide can no longer be reduced after crystallization. The water used for brine production is rarely drinking water, but in most cases it is surface water. It is possible for germs to be introduced into the crude brine, and a clear barrier for germs is absent in the standard salt works process.

Numerous methods for purifying salt brine are described in the literature. With regard to the removal of sulfate and carbonate salts, a differentiation is made between oxidation methods, liming methods, and chemical purification methods. Purification of the brine often takes place with the goal of obtaining the products produced from the brine, such as evaporated salt, caustic soda, or soda, with great purity. Furthermore, deposits of salts with low solubility, for example of the earth alkali metals, are to be prevented, since these reduce the performance capacity and useful lifetime of the system parts. Amounts of brine that must necessarily be passed out of the process are frequently reduced for economic and ecological reasons.

With the oxidation method, intensive aeration of the brine takes place, iron and manganese precipitate as hydroxides with low solubility, and calcium and magnesium as carbonates.

With the liming method, milk of lime is added to the brine, which has been heated to approximately 80° C., and calcium sulfate salts and magnesium hydroxide precipitate.

Lime soda purification is well-known. This established process, also called Schweizerhalle process, is described, for example, in the Austrian patent 7198 and in German patent 140605. In this process, magnesium is precipitated almost completely as magnesium hydroxide, in the first stage, by means of calcium hydroxide, which can be introduced into the solution as lime water or burned lime. At the same time, sulfate ions that are found in the solution are precipitated as calcium sulfate, which has low solubility, to a certain proportion, so that a reduction of the calcium content in the solution takes place. In this connection, the formation of caustic soda also effectively takes place, because calcium ions and sulfate ions precipitate as gypsum, and sodium ions and hydroxide ions remain in the solution. Therefore, the pH of the solution rises. In the second stage of the Schweizer-Halle process, soda (sodium carbonate) is used, in order to almost completely precipitate the remaining calcium ions as calcium carbonate. The secondary components of the brine, bromide and potassium pass through the brine purification without any separation effect. The reduction of sulfate is limited, because it is based on the formation of calcium sulfate, which still possesses a noteworthy solubility in salt brine.

Blowing in carbon dioxide as a flue gas, in the second stage of the Schweizerhalle process, is a usual method for being able to save soda. Caustic soda that has formed from sodium sulfate and lime in the first stage is converted into soda in the second stage, in this manner. Precipitated contaminants can be separated from the clear, purified brine after every stage, by decanting or filtration. In this connection, flocculants improve the clarification process.

In the literature, there are numerous treatises concerning the evaporation of purified brine, i.e. the evaporation of water from the brine, with the goal of obtaining salt crystals [e.g. ULLMANN'S ENCYCLOPEDIA OF INDUSTRIAL CHEMISTRY, Release 2005, 7th edition, “sodium chloride”]. Evaporation is usually carried out in multi-stage evaporation systems. The mother liquor that remains in this process has become enriched with secondary components as compared with the purified brine, because chemically highly pure sodium chloride has crystallized out, and water has evaporated out. These components particularly include sulfate, bromide, and potassium. If one were to completely reject the mother liquor, this would result in a loss of NaCl, and a noteworthy amount of waste water containing a lot of salt would occur. Partial recirculation of the mother liquor into the brine purification process is therefore the usual path. An economically important reason for this is the possibility of being able to save soda in this way. The high sulfate content of the mother liquor promotes the formation of calcium sulfate in the first stage of the Schweizerhalle process, so that a solution with reduced calcium content gets into the second stage. In this manner, soda is saved in the second stage, because there, only the residual amount of calcium is precipitated by means of soda. Furthermore, because of the recirculation of sodium sulfate, the amount of caustic soda formed from calcium hydroxide is increased in the first stage. This caustic soda can also be additionally converted to soda by blowing in flue gas in the second stage. The effect of blowing in flue gas therefore increases when recirculating mother liquor. If mother liquor is recirculated as a precipitant, secondary components such as bromide and potassium also get into the purified brine in high concentrations. The pure brine is then richer in bromide and potassium, for example, than would be the case without using mother liquor. The products produced from this brine, such as evaporated salt, then also have higher proportions of these secondary components, and this is not desirable.

The production of a evaporated salt that is particularly low in bromide usually takes place in multi-stage evaporation systems. Because bromide preferably remains in solution during crystallization, the salt of the first stages, which is lower in bromide, can be sold as a separate product, such as described, for example, in Akzo, P. Jongema, Production of Low Bromine-Containing Evaporated Salt, 7th Symposium on Salt, Vol. II 159-163 (1993). The solution, which has become enriched in bromide, is thereby passed on to the next colder stage. In the case of recirculation of mother liquor, there is a conflict between sparing use of purchased precipitants such as soda, and a high quality of the purified brine with regard to bromide and potassium.

In order to be able to produce a brine having a high degree of purity, while nevertheless using purchased precipitants sparingly, separation of the sulfate ions from the salt brine and, in particular, from the mother liquor, is proposed in some publications. In this connection, ion exchangers for separating sulfate ions are described, in particular Japanese Patent No. 04321514-A, Japanese Patent No. 04338110-A, Japanese Patent No. 04334553-A, and U.S. Pat. No. 4,556,463. However, the ion exchanger methods described in these references, for the greatest possible reduction in the sulfate ion concentration, have not established themselves in practice, since complicated regeneration processes are necessary, which furthermore produce larger amounts of dilute salt solutions, the use and/or disposal of which raises ecological problems. The mode of operation of these expensive systems, which is usually discontinuous, is another disadvantage for use in large industrial processes operated continuously.

European Patent No. 0492727 describes that an improvement as compared with direct recirculation of mother liquor can be represented by means of crystallization of a sodium sulfate/sodium chloride mixture from the mother liquor. In this connection, a crystallizate is produced that is enriched in sodium sulfate but still mixed with large proportions of sodium chloride. The crystal mixture is recirculated into the brine purification process, in place of the mother liquor. Depending on the saturation conditions of the crude brine, dilution with water might become necessary. The investment expenditure and operating costs of such a crystallizer is high. It is proposed to separate NaCl that has also been crystallized, as a product, in that the sodium sulfate is selectively dissolved in brine. Experience has shown that such an NaCl will have unacceptably high contents of sodium sulfate, since intergrowth of the two types of crystals will occur during crystallization. The NaCl proportion obtained in the salt mixture is furthermore rich in bromide, so that in the case of recirculation into brine purification, bromide is unintentionally recirculated, as in the case of the mother liquor.

Swiss Patent No. 454796 and Great Britain Patent No. 1139625 disclose the crystallization of sodium sulfate and sodium chloride at two temperatures in two separate crystallizers, which communicate by means of “pendulating” solution exchange (“pendulum method”). The two salts then crystallize separately. In this connection, it is supposed to be possible to obtain the sodium sulfate as an almost pure crystallizate, and recirculate it into the brine purification process as such. However, the problem of the high investment and operating expenditure remains, and regulation problems are added. In the crystallization of the pure sodium sulfate, bromide is still contained essentially only in the adhering mother liquor of the crystals, which are wet from the centrifuge. This mother liquor can be washed off with fresh brine and thereby displaced, making is possible to produce NaCl crystallizate that is low in bromide. An advantage of this pendulum method is the almost complete separation of the sulfate from bromide and potassium contaminants.

Furthermore, membrane separation methods such as nanofiltration are known for separating sulfate ions and chloride ions. Such nanofiltration of salt brines, with the goal of sulfate separation, is described, for example, in U.S. Pat. No. 5,858,240, U.S. Pat. No. 5,587,083 and European Patent No. 0821615 B1. With this separation method, the salt brine that is fed in and contains sulfate is separated into a concentrate (retentate) that is enriched in sulfate, and a permeate that is low in sulfate. The sodium ions are present in the correct ratio to sulfate ions and chloride ions, respectively, in the two separated fractions, because of the charge balancing that takes place. According to the stated references, the sulfate-rich fraction, which occurs as concentrate, is not utilized. The goal is the reduction of a rejection stream of a production process that continues to exist. Chlor-alkali electrolysis, sodium hypochloride production, and sodium chlorate production are mentioned as production methods.

One way to accumulate sodium sulfate from a mother liquor in evaporated salt production, in a multi-stage evaporation process, is disclosed by European Patent No. 1202931 B1. In the method described, nanofiltration of the mother liquor is carried out, in order to be able to recirculate the concentrate (retentate) that is obtained back into the brine purification process, with a reduced bromide load, among other things. The method of the state of the art contains the following method steps:

a) Precipitation of bivalent cations from the salt brine by means of one or more precipitation steps;

b) Single-stage or multi-stage evaporation of the salt brine pretreated according to step (a);

c) Separation of the mother liquor that occurs in step (b) into a concentrate and a permeate, by nanofiltration; and

d) Recirculation of the concentrate at step (a), as a precipitation reagent.

Because the nanofiltration modules can only be operated below saturation, there is a limit for the separation of the bromide from the sulfate. According to European Patent No. 1202931, the mother liquor of the next to last stage is used as the feed for nanofiltration; it is not yet saturated with regard to sodium sulfate. Brine or water is used for dilution. This diluted mother liquor is concentrated up to sodium sulfate saturation, and the concentrate is recirculated. The permeate, which is low in sulfate, is further concentrated in the last evaporator stage, until saturation of potassium salts is reached; this residual solution is rejected.

In the case of use of nanofiltration, as described, a concentrated brine having 50%, for example, of the saturation concentration of sodium sulfate is selected as the feed. This brine can be concentrated maximally up to half, until sodium sulfate saturation would occur. In this connection, the load of bromide is also cut in half, because only 50% of the solution amount contains only half of the bromide, calculated as mass, with the same bromide concentration. A certain additional reduction in the bromide load results by way of negative retention coefficients of the bromide in the concentrated solutions, i.e. bromide is quasi pushed through the membrane in the direction of the permeate, therefore the bromide concentration in the concentrate is also lower than in the feed. However, the almost perfect separation that occurs in the pendulum method cannot be achieved with this method.

Strict requirements must be set for the solution applied to nanofiltration, the so-called feed, so that the membranes do not suffer any damage. These include a temperature of <40° C. in the case of standard construction, a pH that is not too high, a low proportion of microparticles, and a slight under-saturation of the solution, so that no crystals can form on the membrane. These requirements can only be assured, in the case of nanofiltration of a mother liquor, with great effort and expenditure, because the mother liquor is completely saturated with regard to NaCl, it is usually warmer than desirable, it contains small salt particles, and it has a clearly higher pH than the purified brine, because of the concentrating evaporation. The saturation is the reason for mixing the mother liquor with brine or water for dilution. Such dilution increases the volume stream to be filtered. The use of water, in particular, is counter-productive in terms of energy, since it has to be evaporated out again later.

Complete separation of the bromide from the sulfate is not possible by nanofiltration of the mother liquor. This approach is therefore fundamentally disadvantageous as compared with that of crystallization of pure sodium sulfate in the case of the “pendulum method.” Technical problems with the resistance of the membrane to the mother liquor must furthermore be expected if extensive protective measures are not taken.

### SUMMARY OF THE INVENTION

It is therefore an object of the present invention to reduce the amount of soda used as a precipitant in chemical crude brine purification as much as possible, without thereby increasing the bromide content of the purified brine as compared with that of the crude brine. In this connection, a great reduction in the sulfate content of the pure brine as compared with the crude brine is achieved. Purification of the crude brine from germs and endotoxins, to produce a pyrogen-free pure brine, is another object of the invention. The pure brine produced in this manner is suitable for crystallizing a sodium chloride low in sulfate and free of pyrogens, and furthermore the greatest possible fraction of NaCl low in bromide, by means of conventional multi-stage evaporation. In this connection, comparable results as in the case of the pendulum method are achieved with regard to the specific consumption of precipitants and the pure brine quality.

These tasks are accomplished according to the invention by a method having the following steps:

a) Precipitating bivalent cations with sulfate ions and hydroxide ions in a first stage,

b) Precipitating remaining bivalent cations with carbonate ions and blowing in flue gas, in a second stage,

c) Separating the brine from step (b) into concentrate and permeate, by means of nanofiltration, in a directly following third stage, wherein the permeate is the product, in the form of purified brine, and

d) Recirculating the concentrate into the first stage (a).

It was found that a clear improvement as compared with the state of the art occurs as the result of nanofiltration of the brine directly after two-stage chemical brine purification according to the Schweizerhalle process, with recirculation of the concentrate into the first stage of this brine purification, and utilization of the permeate as pure brine. It was furthermore found that the method is also efficient as compared with the “pendulum method,” and that it is possible to design such a nanofiltration system cost-effectively, using standard components that are available on the market.

It is proposed, according to the invention, to subject the brine to nanofiltration after the second stage of the Schweizerhalle process. This brine does not yet have any increased contents of bromide and potassium, so that the disadvantage of incomplete sulfate separation cannot have a negative effect. The concentrate stream, which has been enriched in sulfate, is recirculated into the first stage of brine purification, in order to precipitate calcium sulfate there to a greater degree, and to achieve the desired soda saving in the second stage. In this connection, bromide and potassium in the solution remain constant, to a great extent. Since the nanofiltration is carried out at lower entry concentrations of sulfate, the degree of sulfate retention and the permeate flow per surface area increases. The pH of the purified brine is lower than after evaporation; the brine is under-saturated with regard to NaCl, freshly clarified, and does not have to be cooled, but rather possibly heated, in order to achieve an advantageous operating temperature of approximately 35° C. No crystal formation can occur during heating of the solution. In this way, advantageous prerequisites for gentle operation of the nanofiltration membranes, with long useful lifetimes, are created. In principle, all of the commercially available nanofiltration membranes can be used as membranes, if their permissible operating parameters include the desired range of use. The economically optimal membrane should be determined in a pilot plant, by long-term experiments; in this connection, the useful lifetime is an economically important factor. There is no fixed binding of the invention to a specific membrane type.

In the case of a crude brine composition having a high stoichiometric excess of sulfate to calcium, good water removal from the sludge from the chemical purification steps, for example by means of filter pressing, and a high membrane retention coefficient of the nanofiltration stage, the recirculated sulfate can enrich in the circuit to such an extent that the saturation limits for sodium sulfate in nanofiltration are reached, i.e. that further recirculation does not result in any increase in soda saving. In this case, as shown in FIG. 4a, an additional, controlled rejection of sulfate from the circulation must be made possible. For this, the following ways are possible, among others: Use of a nanofiltration membrane having lower sulfate retention, bypass stream past the membrane, rejection of a part of the concentrate, increase in the residual moisture in water removal from sludge, addition of calcium chloride in the first brine purification stage for the precipitation of excess sulfate as calcium sulfate.

Nanofiltration becomes an integral part of the brine purification system in the manner described, and represents the third purification stage there. The brine purification process can be operated independently and locally separate from the consumer of the brine. The consumer of the brine can be, for example, a salt works, an electrolysis, or a soda factory. In some salt works, the brine purification process is installed in the vicinity of the brine field, in order to be able to place the brine purification sludges that occur into old caverns. A single line for purified brine then connects the brine purification with the salt works. At the end of the process, the salt works disposes of a certain amount of brine, for example into a river or into the ocean.

Recirculation of mother liquor into the brine purification would only be possible by constructing a second pipeline to the brine purification system. In the case of the method according to the invention, however, the nanofiltration is part of the brine purification system; a return line for mother liquor is not necessary. In this way, an improvement also becomes possible for those brine purification facilities that work for several customers and in which the subsequent process does not represent a salt works, but a reduction in the soda consumption and furthermore a reduction of the sulfate content of the brine to the customer is nevertheless desirable.

Those methods in which the membrane retention coefficient R of the nanofiltration step is>90% for sulfate ions, better>95%, are preferred for the nanofiltration stage. The coefficient varies, among other things, with the pressure and the sulfate ion concentration. The membrane retention coefficient for chloride ions is preferably supposed to lie between 0-5%.

The permeate of nanofiltration, which is low in sulfate, in other words the brine after the third brine purification stage, is the product of the brine purification method according to the invention, as pure brine. This pure brine can be the input stream for a conventional multi-stage evaporation process. The crystallizing salt will have a desired low bromide content in the first stages, but will also have a non-typical low sulfate content in all of the crystallizer stages. Accordingly, no sulfate is introduced into the evaporation crystallization at all, but instead, it is already removed from the solution in advance. The sulfate content of the salt will assume very low values because of this, even with doing without washing water on the centrifuges. This is a clear improvement as compared with the state of the art. Recirculation of mother liquor becomes superfluous, because the brine, which is low in sulfate, can be evaporated to a greater degree than before. No enriched bromide is recirculated any longer. A greatly reduced amount of mother liquor in the last stage is completely transported out.

In addition to the properties of the evaporated salt crystallized out of the brine purified according to the invention, as described, such as a low bromide content and sulfate content, the contents of bivalent cations such as calcium and magnesium in the salt are also clearly reduced, because these ions, too, are greatly held back by the nanofiltration membrane. The evaporated salt produced in this manner, as a highly pure, low-bromine salt, fulfills even the strictest requirements for chlor-alkali electrolysis. Purification steps within the electrolysis circuit can thereby be relieved to a great extent, making it possible to save costs, and this grants the evaporated salt produced according to the invention advantageous market opportunities as an extra-pure, low-bromine evaporated salt.

With the brine purification process according to the invention, the entire brine has preferably passed through the nanofiltration membrane as the third stage. The pure brine is then exclusively the permeate of the nanofiltration. The sulfate content of the salt crystallized from this brine is greatly reduced. The production of low-bromide salt is facilitated by the process according to the invention, because the parameter for bromide, which is frequently limited for pharmaceutical salt by legislation, can be better adhered to.

This pure brine has undergone filtration also with regard to large organic molecules, germs, or endotoxins, by means of the nanofiltration, and this represents an important quality characteristic for use of the salt crystallized from it in a salt works. Because of the retention of the nanofiltration membrane for larger organic compounds as well, separation of foam-forming organics, which enter the brine from surface water, for example, as well as remaining flocculants, for example from use in the pre-purification stages according to the Schweizerhalle method, is possible. Because of the retention of nanofiltration for bivalent ions, calcium carbonate can also be retained, so that the use of anti-scaling agents after nanofiltration can be eliminated. Contaminants entrained as particles are also retained by the nanofiltration. In order not to impair the effectiveness of nanofiltration for the retention of the aforementioned contaminants, a bypass stream, as indicated in FIG. 4a, has to be eliminated, and if necessary, another one of the methods explained above for reducing the sulfate recirculation has to be selected. However, a bypass of brine is possible if the pharmaceutical salt is obtained in one of the first evaporator stages, and the bypass is introduced into one of the subsequent stages.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a two-stage chemical brine purification with subsequent five-stage evaporation without recirculation of mother liquor;

FIG. 2 shows a two-stage chemical brine purification with subsequent four-stage evaporation, wherein a partial stream of mother liquor from the fourth evaporator stage is recirculated into brine purification, and the rest of the mother liquor is further concentrated in a fifth evaporator stage;

FIG. 3 shows a two-stage chemical brine purification with subsequent four-stage evaporation, wherein the mother liquor from the fourth evaporator stage, except for a bypass of 1.4 t/h, is nanofiltered, the concentrate is recirculated into brine purification, and the permeate is further concentrated in a fifth evaporator stage as described in European Patent No. 1202931;

FIG. 4 shows the method according to the invention, with two-stage chemical brine purification, subsequent nanofiltration with 15.9 t/h bypass, subsequent five-stage evaporation of the pure brine, and recirculation of the concentrate into the two-stage chemical brine purification; and

FIG. 4a shows the three brine purification stages according to the invention in detail.

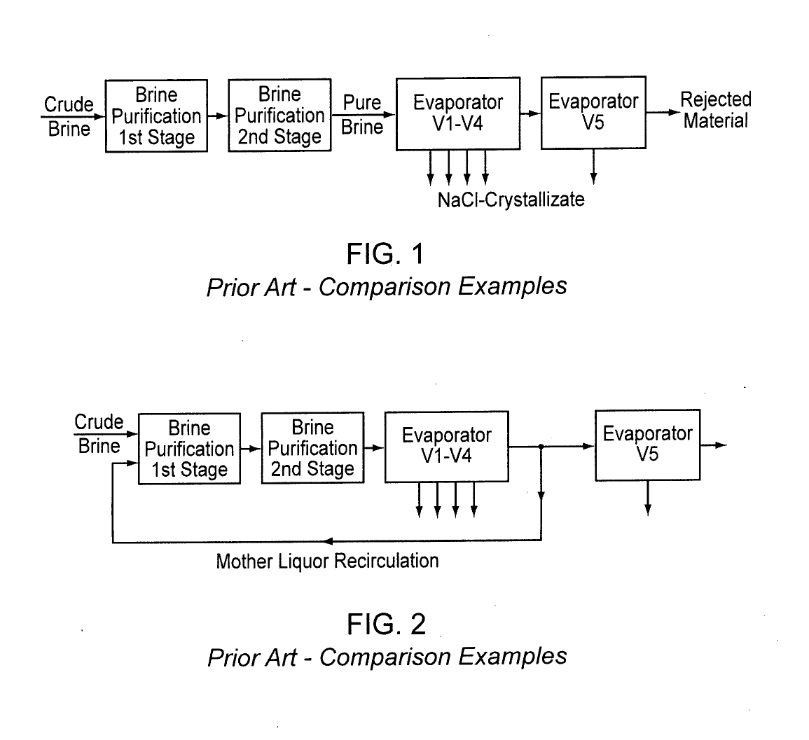

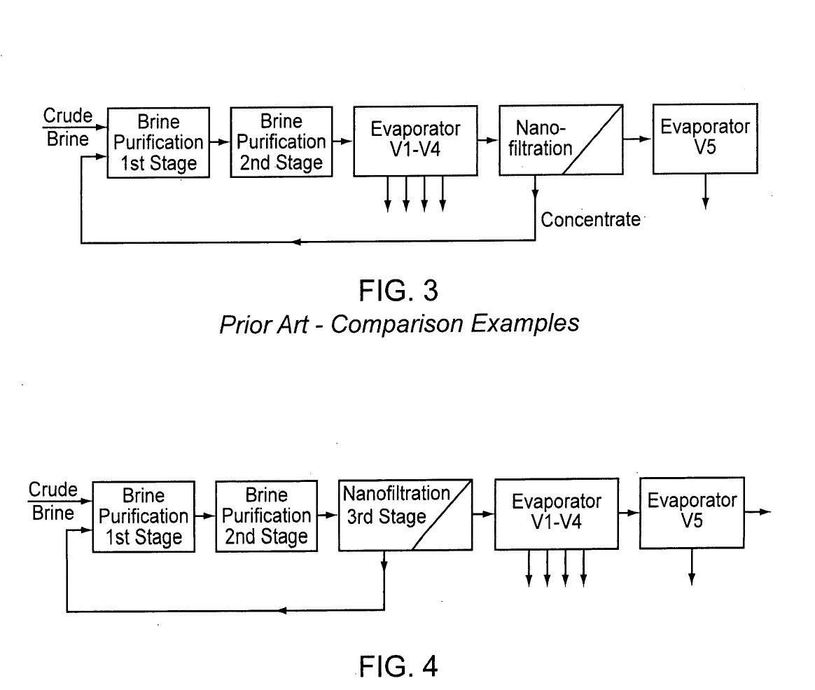

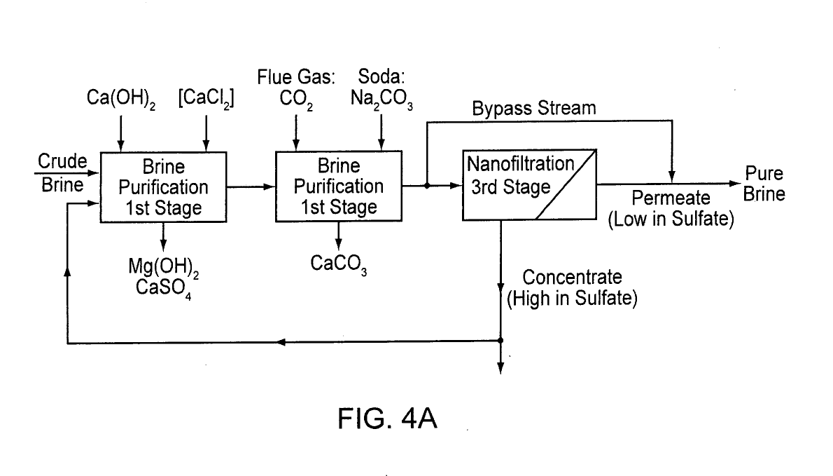

### DETAILED DESCRIPTION OF THE PREFERRED EMBODIMENT

The methods to be compared contain a two-stage chemical brine purification according to Schweizerhalle, in each instance. The lime excess in the first stage of the brine purification, beyond the magnesium content, is 25 mmol/l hydroxide ions, and it, like the remaining hydroxide ion content of 2.9 mmol/l, is the same in all the examples, after stage 2. In all the examples, the crude brine has the following chemical composition per kg of solution: 253 g/kg NaCl, 3.70 g/kg sulfate, 0.804 g/kg calcium, 0.328 g/kg magnesium, 1.079 g/kg potassium, 0.070 g/kg bromide. The pure brine is completely introduced into the first evaporator stage, and the exiting stream is then passed serially from stage to stage, in the same manner. The multi-stage evaporation has five stages, in each instance. The water evaporation of all five evaporator stages, which are switched in series, is assumed to be the same, in this connection, a total of 69 wt. −% of the crude brine. The same water evaporation per stage approximately corresponds to the usual serial thermal switching. The maximal value of 40.8 g sulfate/kg solution was adhered to for the concentration of sulfate ions at the exit of the last evaporator, i.e. in the concentrate of the nanofiltration. The amount ratio of the recirculation stream (mother liquor or concentrate, respectively) to the crude brine stream in case 2-4 was always the same, at 27 wt. −%. Cases 1 and 2 were carried out without nanofiltration, cases 3 and 4 with nanofiltration. Case 1 should be viewed as a comparison case for the chemical quality of the pure brine and the boiled salt crystallized from it, because here, no brine chemically enriched with secondary elements is recirculated. Case 2 should be viewed as a comparison case for soda consumption (100%), because it is the series that is conventionally usual. Case 3 corresponds to the patent EP 1 202 931. According to this patent, evaporation in one or more stages takes place before the nanofiltration, in four stages in the comparison case. After nanofiltration, the permeate is optionally concentrated further, here in one stage.

Case 4 represents the invention. In cases 2 and 3, a step takes place after evaporator stage 4, in which the mother liquor is partly recirculated into the first stage of brine purification, or in which the mother liquor is nanofiltered and the concentrate is recirculated, respectively, and the evaporators 1-4 are included in the recirculation circuit. In cases 1 and 4, on the other hand, brine purification and crystallization are strictly separate. The calculations of the examples were carried out using the calculation formulas listed in the annex of the patent EP 1 202 931 (herein incorporated by reference), which are based on mass balances that are generally known to a person skilled in the art.

TABLE 1
Comparison of the four method variants for boiled salt production

| | Case 1 | Case 2 | Case 3 | Case 4 |
|---|---|---|---|---|
| Relative soda | 123% | 100% | 15% | 15% |
| consumption | | | | |
| Ratio of bromide | 1.0 | 1.5 | 1.5 | 1.0 |
| content of | | | | |
| the pure | | | | |
| brine/crude brine | | | | |
| Ratio of | 0.8 | 1.1 | 2.5 | 0.18 |
| sulfate content | | | | |
| of the pure | | | | |
| brine/crude brine | | | | |
| Ratio of | 11.0 | 9.6 | 2.5 | 2.4 |
| sulfate content | | | | |
| of rejected | | | | |
| material/crude | | | | |
| brine | | | | |
| Rejection | 7.3% | 7.3% | 7.3% | 7.3% |
| amount after | | | | |
| evaporator | | | | |
| 5/crude brine | | | | |
| ppm bromide | 13.4 | 19.8 | 19.2 | 13.5 ppm |
| in the salt | | | | |
| of the | | | | |
| evaporator 1 | | | | |
| ppm bromide | 130 | 130 | 130 | 130 ppm |
| in the salt | | | | |
| of the | | | | |
| evaporator 5 | | | | |

In Case 1, no mother liquor was recirculated, the material exiting from the evaporator 5 was completely rejected. The rejection stream of 7.3% of the crude brine amount is the smallest possible rejection stream, in this case, because the saturation limit for sulfate is reached in the rejected material of the evaporator 5. This rejection amount and the related bromide content in the evaporator 5 were set to be constant for all the other cases.

In case 2, a partial stream of the mother liquor was recirculated into the brine purification after evaporator 4, and the remaining amount continued to be evaporated in the evaporator 5. The bromide content in the pure brine and therefore in the salt of evaporator 1 has clearly increased, but the soda consumption has only decreased moderately. The sulfate content of the rejected material shows that a certain reduction of the rejection stream is still possible, if higher bromide contents in the salt of evaporator 5 are permissible.

In Case 3, almost the entire mother liquor was nanofiltered after the fourth evaporator stage, and the concentrate was recirculated. The permeate was further evaporated in the fifth evaporator stage. The soda consumption decreases greatly, to 15% of the value of Case 2. The sulfate content of the pure brine and therefore in the evaporator stages 1-4 has more than doubled, only in the evaporator stage 5 is there an improvement as compared with Case 2. The salt qualities consequently deteriorate in the evaporator stages 1-4, with regard to sulfate, and improve in the evaporator stage 5. The bromide contents in the salt remain unchanged. In this connection, it should be noted that the dilution before nanofiltration, which is additionally necessary in practice, would make this comparison noticeably worse. The freedom of movement for reducing the rejection stream is still clearly greater than in Case 2, but again with the effect of a higher bromide content in the salt of the evaporator 5.

Case 4 represents the new method according to the invention, in which the brine was nanofiltered, for the greatest part, after the second chemical purification stage, and the concentrate was recirculated. The pure brine now has the same bromide content as the crude brine, as in Case 1, while the sulfate content furthermore has an unsurpassedly low value. The same salt quality with regard to bromide can be represented in the five evaporator stages as in Case 1. The soda consumption has the same low value as in Case 3. Case 4, according to the invention, is therefore most advantageous in all points of comparison. Here again, as in Case 3, the rejected material can be reduced, if higher bromide contents in the salt of the evaporator 5 are permissible.

Accordingly, while only a few embodiments of the present invention have been shown and described, it is obvious that many changes and modifications may be made thereunto without departing from the spirit and scope of the invention.

1. A method for the treatment of salt brine, comprising the following steps:
a) precipitating bivalent cations from the brine with sulfate ions and hydroxide ions in a first stage;
b) precipitating remaining bivalent cations from the brine with carbonate ions and blowing in flue gas, in a second stage;
c) separating the brine from step (b) into concentrate and permeate, by means of nanofiltration, in a directly following third stage, wherein the permeate is a product, in the form of purified brine; and
d) Recirculating the concentrate into the first stage (a).

2. The method according to claim 1, wherein the nanofiltered permeate from step (c) has a reduced concentration of bivalent ions as compared with untreated brine.

3. The method according to claim 1, wherein a partial stream of the concentrate from step (d) is passed out of the process.

4. A method according to claim 1, wherein a partial stream of the brine from step (b) bypasses the nanofiltration.

5. A method according to claim 1, wherein bivalent cations are added in step (a).

6. A method according to claim 1, further comprising the step of crystallizing the purified brine from step (c) to produce a pure evaporated NaCl salt in a multi-stage evaporation crystallization process, the salt being depleted in bromine and sulfate and free of pyrogens.
